(19) United States
(12) Patent Application Publication
(10) Pub. No.: US 2012/0017208 A1
(43) Pub. Date: Jan. 19, 2012

(54) SYSTEM AND METHOD FOR UPDATING DEVICE DRIVERS

(76) Inventors: MARK LUSSIER, Mount Pleasant, SC (US); Rob Cheng, Myrtle Beach, SC (US); Lyle Schuknecht, Lake View, IA (US); Carlos Augusto Souza de Almeida Matos, Rio de Janeiro (BR)

(21) Appl. No.: 12/835,880

(22) Filed: Jul. 14, 2010

(51) Int. Cl. G06F 9/445

(52) U.S. Cl. 717/174

(57) ABSTRACT

A computer-implemented method, computer program product, and computing system for scanning a computing device to identify a plurality of devices included within the computing device, thus generating a list of identified devices. The list of identified devices is compared to a master list of supported devices to identify a list of supported identified devices. A device driver is obtained for each supported identified device included within the list of supported identified devices, thus generating a plurality of obtained device drivers. The plurality of obtained device drivers are installed onto the computing device.

### TECHNICAL FIELD

This disclosure relates to device drivers and, more particularly, to systems and methods for installing device drivers.

### BACKGROUND

While computing devices appear to be unitary systems, computing devices are actually assembled from a plurality of individual, discreet devices. Examples of such devices may include but are not limited to: video cards, I/O controllers, memory controllers, keyboard controllers, hard drives, and optical drives. In order for these discrete devices to be able to properly communicate, the appropriate driver needs to be installed for each device. Typically these drivers vary depending upon the device and the operating system being executed.

The device drivers may be updated quite often to address changes in operating systems, to fix bugs, or to improve performance. Unfortunately, when updating a driver, the user first needs to locate and download the current driver (which may prove difficult for one of modest computer skills). Further, once located and downloaded, they need to be installed through an often complex update procedure.

### SUMMARY OF DISCLOSURE

In a first implementation, a computer-implemented method includes scanning a computing device to identify a plurality of devices included within the computing device, thus generating a list of identified devices. The list of identified devices is compared to a master list of supported devices to identify a list of supported identified devices. A device driver is obtained for each supported identified device included within the list of supported identified devices, thus generating a plurality of obtained device drivers. The plurality of obtained device drivers are installed onto the computing device.

One or more of the following features may be included. A previously-installed device driver may be identified for each identified device included within the list of identified devices. A device driver repository may be maintained that includes a current device driver for each supported device included within the master list of supported devices. The status of each previously-installed device driver included within the list of identified devices may be compared to the status of each corresponding current device driver included within the device driver repository. If the current device driver is newer than the previously-installed device driver, the current device driver may be included within the plurality of obtained device drivers.

Comparing the status of each previously-installed device driver may include one or more of: comparing the version number of each previously-installed device driver to the version number of each corresponding current device driver; comparing the age of each previously-installed device driver to the age of each corresponding current device driver; and comparing the release date of each previously-installed device driver to the release date of each corresponding current device driver. A user may be allowed to remove one or more device drivers from the plurality of obtained device drivers.

In another implementation of this disclosure, a computer program product resides on a computer readable medium and has a plurality of instructions stored on it. When executed by a processor, the instructions cause the processor to perform operations including scanning a computing device to identify a plurality of devices included within the computing device, thus generating a list of identified devices. The list of identified devices is compared to a master list of supported devices to identify a list of supported identified devices. A device driver is obtained for each supported identified device included within the list of supported identified devices, thus generating a plurality of obtained device drivers. The plurality of obtained device drivers are installed onto the computing device.

One or more of the following features may be included. A previously-installed device driver may be identified for each identified device included within the list of identified devices. A device driver repository may be maintained that includes a current device driver for each supported device included within the master list of supported devices. The status of each previously-installed device driver included within the list of identified devices may be compared to the status of each corresponding current device driver included within the device driver repository. If the current device driver is newer than the previously-installed device driver, the current device driver may be included within the plurality of obtained device drivers.

Comparing the status of each previously-installed device driver may include one or more of: comparing the version number of each previously-installed device driver to the version number of each corresponding current device driver; comparing the age of each previously-installed device driver to the age of each corresponding current device driver; and comparing the release date of each previously-installed device driver to the release date of each corresponding current device driver. A user may be allowed to remove one or more device drivers from the plurality of obtained device drivers.

In another implementation, a computing system includes at least one processor and at least one memory architecture coupled with the at least one processor. A first software module is executed on the at least one processor and the at least one memory architecture. The first software module is configured to perform operations including scanning a computing device to identify a plurality of devices included within the computing device, thus generating a list of identified devices. A second software module is executed on the at least one processor and the at least one memory architecture. The second software module is configured to perform operations including comparing the list of identified devices to a master list of supported devices to identify a list of supported identified devices. A third software module is executed on the at least one processor and the at least one memory architecture. The third software module is configured to perform operations including obtaining a device driver for each supported identified device included within the list of supported identified devices, thus generating a plurality of obtained device drivers. A fourth software module is executed on the at least one processor and the at least one memory architecture. The fourth software module is configured to perform operations including installing the plurality of obtained device drivers onto the computing device.

One or more of the following features may be included. A previously-installed device driver may be identified for each identified device included within the list of identified devices. A device driver repository may be maintained that includes a current device driver for each supported device included within the master list of supported devices. The status of each previously-installed device driver included within the list of identified devices may be compared to the status of each corresponding current device driver included within the device driver repository. If the current device driver is newer than the previously-installed device driver, the current device driver may be included within the plurality of obtained device drivers.

Comparing the status of each previously-installed device driver may include one or more of: comparing the version number of each previously-installed device driver to the version number of each corresponding current device driver; comparing the age of each previously-installed device driver to the age of each corresponding current device driver; and comparing the release date of each previously-installed device driver to the release date of each corresponding current device driver. A user may be allowed to remove one or more device drivers from the plurality of obtained device drivers.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a driver update process executed in whole or in part by a computer coupled to a distributed computing network; and

FIG. 2 is a flowchart of the driver update process of FIG. 1.

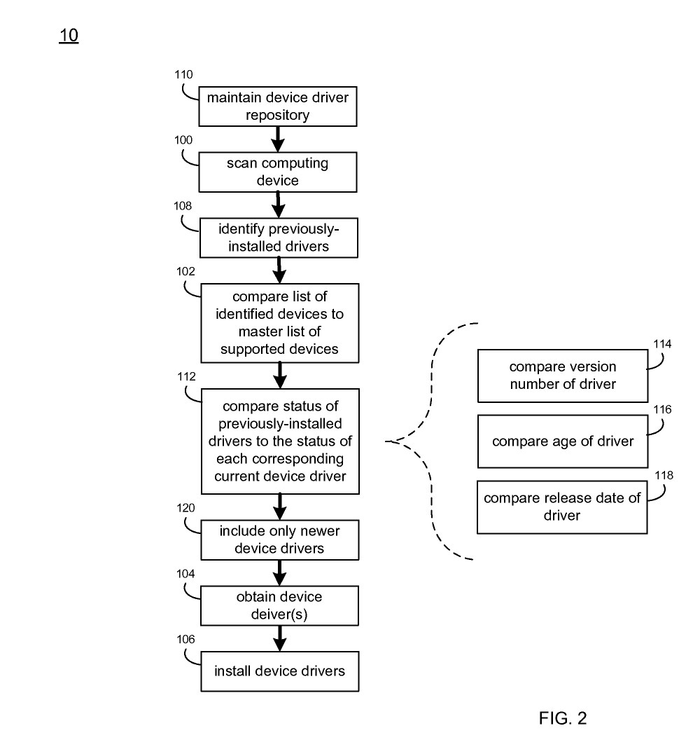

Like reference symbols in the various drawings indicate like elements.

### DETAILED DESCRIPTION OF THE PREFERRED EMBODIMENTS

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

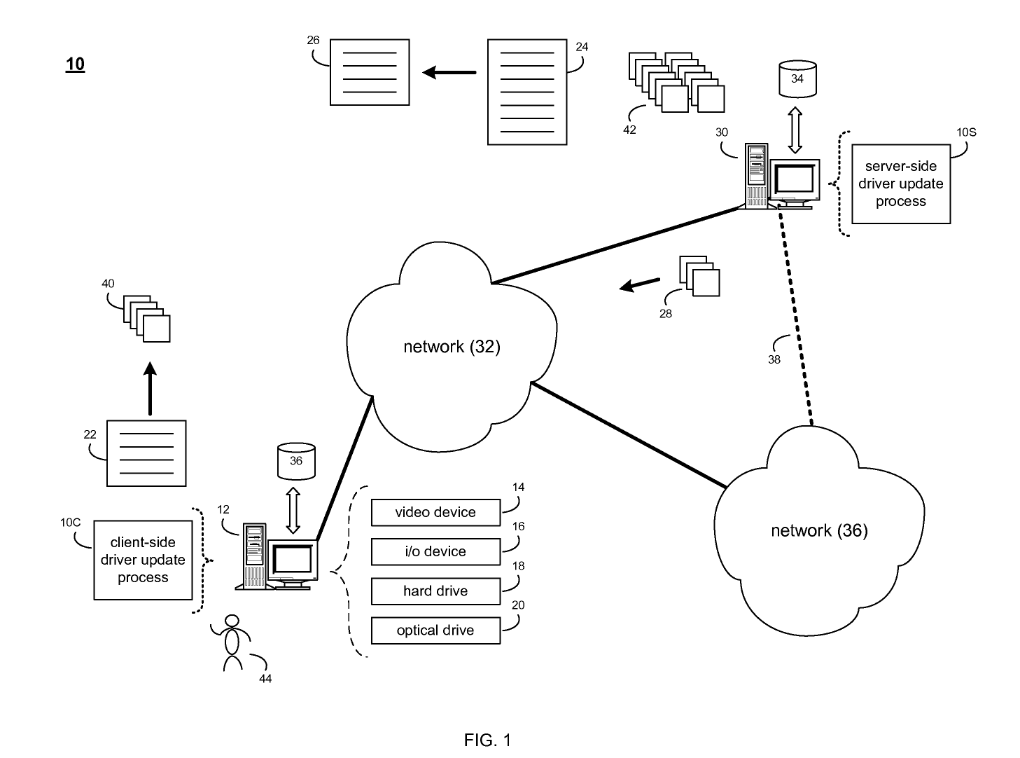

Referring to FIGS. 1 & 2, there is shown driver update process 10 that may scan 100 a computing device (e.g., client computer 12) to identify a plurality of devices (e.g., video device 14, I/O device 16, hard drive 18 and optical drive 20) included within the computing device (e.g., client computer 12), thus generating a list of identified devices (e.g., list of identified devices 22). The list of identified devices (e.g., list of identified devices 22) may be compared 102 to a master list of supported devices (e.g., master list of supported devices 24) to identify a list of supported identified devices (e.g., list of supported identified devices 26). A device driver may be obtained 104 for each supported identified device included within the list of supported identified devices (e.g., list of supported identified devices 26), thus generating a plurality of obtained device drivers (e.g., plurality of obtained device drivers 28). The plurality of obtained device drivers (e.g., plurality of obtained device drivers 28) may be installed 106 onto the computing device (e.g., client computer 12).

Driver update process 10 may be a server-side application (e.g., server-side driver update process 10S executed on server computer 30); a client-side application (i.e., client-side driver update process 10C executed on client computer 12); or a hybrid server-side/client-side application (e.g., server-side driver update process 10S executed on server computer 30 in coordination/cooperation with client-side driver update process 10C executed on client computer 12).

If configured as a server-side application (e.g., server-side driver update process 10S) or a hybrid server-side/client-side application (e.g., server-side driver update process 10S in coordination/cooperation with client-side driver update process 10C), all or a portion of driver update process 10 may reside on and may be executed by server computer 30, which may be connected to network 32 (e.g., the Internet or a local area network). Examples of server computer 30 may include, but are not limited to: a personal computer, a server computer, a series of server computers, a mini computer, and a mainframe computer. Server computer 30 may execute a network operating system, examples of which may include but are not limited to: Microsoft Windows XP Server™; Novell Netware™; and Redhat Linux™.

If configured as a server-side application (e.g., server-side driver update process 10S) or a hybrid server-side/client-side application (e.g., server-side driver update process 10S in coordination/cooperation with client-side driver update process 10C), all or a portion of the instruction sets and subroutines of driver update process 10, which may be stored on storage device 34 coupled to server computer 30, may be executed by one or more processors (not shown) and one or more memory architectures (not shown) incorporated into server computer 30. Storage device 34 may include but is not limited to: a hard disk drive; a tape drive; an optical drive; a RAID array; a random access memory (RAM); and a read-only memory (ROM).

If configured as a client-side application (e.g., client-side driver update process 10C) or a hybrid server-side/client-side application (e.g., server-side driver update process 10S in coordination/cooperation with client-side driver update process 10C), all or a portion of driver update process 10 may reside on and may be executed by client computer 12, which may be connected to network 32 (e.g., the Internet or a local area network). Examples of client computer 12 may include, but are not limited to: a personal computer, a laptop computer, a notebook computer, a tablet computer, a PDA, and a data-enabled cell phone. Client computer 12 may execute an operating system, examples of which may include but are not limited to: Microsoft Windows™; and Redhat Linux™.

If configured as a client-side application (e.g., client-side driver update process 10C) or a hybrid server-side/client-side application (e.g., server-side driver update process 10S in coordination/cooperation with client-side driver update process 10C), all or a portion of the instruction sets and subroutines of driver update process 10, which may be stored on storage device 36 coupled to client computer 12, may be executed by one or more processors (not shown) and one or more memory architectures (not shown) incorporated into client computer 12. Storage device 36 may include but is not limited to: a hard disk drive; a tape drive; an optical drive; a RAID array; a random access memory (RAM); and a read-only memory (ROM).

For illustrative purposes only, driver update process 10 will be generically discussed without reference to the computer that is executing driver update process 10, with the understanding that driver update process 10 may be a server-side application; a client-side application; or a hybrid server-side/client-side application.

Server computer 30 may execute a web server application, examples of which may include but are not limited to: Microsoft IIS™, Novell Webserver™, or Apache Webserver™, that allows for HTTP (i.e., HyperText Transfer Protocol) access to server computer 30 via network 32. Network 32 may be connected to one or more secondary networks (e.g., network 36), examples of which may include but are not limited to: a local area network; a wide area network; or an intranet, for example. Server computer 30 may be coupled to network 36 via one or more links (e.g., link 38 shown in phantom).

For illustrative purposes, assume that driver update process 10 includes an agent (e.g., client-side driver update process 10C) that resides on and is executed by client computer 12. Further, assume for illustrative purposes that driver update process 10 (via e.g., client-side driver update process 10C) may scan 100 client computer 12 to identify the devices (e.g., video device 14, I/O device 16, hard drive 18 and optical drive 20) included within client computer 12. Driver update process 10 may generate list of identified devices 22, which defines the devices (e.g., video device 14, I/O device 16, hard drive 18 and optical drive 20) included within client computer 12. Driver update process 10 may identify 108 a previously-installed device driver (e.g., previously-installed device drivers 40) for each identified device included within list of identified devices 22. Accordingly, for each device (e.g., video device 14, I/O device 16, hard drive 18 and optical drive 20) included within client computer 12, the driver related to each of those included devices may be identified. For illustrative purposes, these device drivers are collectively referred to as previously-installed device drivers 40, which may include a video device driver, an I/O device driver, a hard drive driver, and an optical drive driver.

List of identified devices 22 may be compared 102 to master list of supported devices 24 to identify list of supported identified devices 26. Master list of supported devices 24 may be a list that defines each device driver included within device driver repository 42. Device driver repository 42 may be maintained 110 by driver update process 10 and may include a plurality of current device drivers available to update e.g., the previously-installed device drivers 40 resident on client computer 12. For example, driver update process 10 may obtain (e.g., from the various device manufacturers) up-to-date drivers for inclusion within device driver repository 42.

As discussed above, client computer 12 includes four devices (e.g., video device 14, I/O device 16, hard drive 18 and optical drive 20) included within client computer 12, each of which is defined within list of identified devices 22. Further and as discussed above, a device driver (e.g., a video device driver, an I/O device driver, a hard drive driver, and an optical drive driver) is defined for each of the four included devices (e.g., video device 14, I/O device 16, hard drive 18 and optical drive 20).

For illustrative purposes, assume that device driver repository 42 includes thousands of up-to-date device drivers. Driver update process 10 may compare 112 the status of each previously-installed device driver included within list of identified devices 22 to the status of each corresponding current device driver included within device driver repository 42. Specifically, driver update process 10 may only update a previously-installed device driver (included within client computer 12) if the corresponding current device driver included within device driver repository 42 is newer/more-current than the previously-installed device driver. For example, when driver update process 10 compares 112 the status of each previously-installed device driver, driver update process 10 may compare 114 the version number of each previously-installed device driver to the version number of each corresponding current device driver to determine which device driver is newer/more current. Alternatively, when driver update process 10 compares 112 the status of each previously-installed device driver, driver update process 10 may compare 116 the age of each previously-installed device driver to the age of each corresponding current device driver to determine which device driver is newer/more current. Alternatively still, when driver update process 10 compares 112 the status of each previously-installed device driver, driver update process 10 may compare 118 the release date of each previously-installed device driver to the release date of each corresponding current device driver to determine which device driver is newer/more current.

For illustrative purposes, assume that after comparing 112 the status of each previously-installed device driver included within list of identified devices 22 to the status of each corresponding current device driver included within device driver repository 42, it is determined that one device driver (e.g., the optical drive driver) is up-to-date) and three device drivers (e.g., the video device driver, the I/O device driver, and the hard drive driver) are in need of updating. Accordingly, while the list of supported identified devices 26 includes four supported identified devices (namely the video device, the I/O device, the hard drive, and the optical drive), as only three of the devices are in need of a device driver update (namely the video device, the I/O device, and the hard drive), driver update process 10 may only include 114 within the plurality of obtained device drivers those device drivers in which the current device driver (as obtained from device driver repository 42) is newer than the corresponding previously-installed device driver resident on client computer 12.

As discussed above and continuing with the above-stated example, driver update process 10 may obtain 104 a device driver for each supported identified device included within the list of supported identified devices (e.g., list of supported identified devices 26), provided that (as discussed above) the current device driver (as obtained from device driver repository 42) is newer than the corresponding previously-installed device driver resident on client computer 12. Accordingly and in this specific example, three newer/more-current device drivers (namely a video device driver, an I/O device driver, and a hard drive driver) will be included within plurality of obtained device drivers 28. Plurality of obtained device drivers 28 may be provided from server computer 30 to client computer 12 as an auto-expanding executable file that may be processed by the agent (e.g., client-side driver update process 10C) included within driver update process 10 that resides on and is executed by client computer 12. The agent may process plurality of obtained device drivers 28 and install the device drivers onto client computer 12.

At e.g., the time of installation or prior to the transmission of plurality of obtained device drivers 28 from server computer 30 to client computer 12, driver update process 10 may allow a user (e.g., user 44) to remove one or more device drivers from the plurality of obtained device drivers. For example, assume that while an older version of the video device driver is installed on client computer 12, whenever user 44 has attempted to update that video driver in the past, compatibility issues arose. Accordingly, user 44 may not want to update the video device driver (even though such an update is available). Accordingly, driver update process 10 may allow user 44 to remove the video device driver from plurality of obtained device drivers 28. Therefore and in this example, only two device drivers (namely an I/O device driver, and a hard drive driver) will be installed onto client computer 12.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

A number of implementations have been described. Nevertheless, it will be understood that various modifications may be made. Accordingly, other implementations are within the scope of the following claims.

What is claimed is:

1. A computer-implemented method comprising:
scanning a computing device to identify a plurality of devices included within the computing device, thus generating a list of identified devices;
comparing the list of identified devices to a master list of supported devices to identify a list of supported identified devices;
obtaining a device driver for each supported identified device included within the list of supported identified devices, thus generating a plurality of obtained device drivers; and
installing the plurality of obtained device drivers onto the computing device.

2. The computer-implemented method of claim 1 further comprising:
identifying a previously-installed device driver for each identified device included within the list of identified devices.

3. The computer-implemented method of claim 2 further comprising:
maintaining a device driver repository that includes a current device driver for each supported device included within the master list of supported devices.

4. The computer-implemented method of claim 3 further comprising:
comparing the status of each previously-installed device driver included within the list of identified devices to the status of each corresponding current device driver included within the device driver repository.

5. The computer-implemented method of claim 4 further comprising:
if the current device driver is newer than the previously-installed device driver, including the current device driver within the plurality of obtained device drivers.

6. The computer-implemented method of claim 3 wherein comparing the status of each previously-installed device driver includes one or more of:
comparing the version number of each previously-installed device driver to the version number of each corresponding current device driver;
comparing the age of each previously-installed device driver to the age of each corresponding current device driver;
comparing the release date of each previously-installed device driver to the release date of each corresponding current device driver;

7. The computer-implemented method of claim 1 further comprising:
allowing a user to remove one or more device drivers from the plurality of obtained device drivers.

8. A computer program product residing on a computer readable medium having a plurality of instructions stored thereon that, when executed by a processor, cause the processor to perform operations comprising:
scanning a computing device to identify a plurality of devices included within the computing device, thus generating a list of identified devices;
comparing the list of identified devices to a master list of supported devices to identify a list of supported identified devices;
obtaining a device driver for each supported identified device included within the list of supported identified devices, thus generating a plurality of obtained device drivers; and
installing the plurality of obtained device drivers onto the computing device.

9. The computer program product of claim 8 further comprising instructions for:
identifying a previously-installed device driver for each identified device included within the list of identified devices.

10. The computer program product of claim 9 further comprising instructions for:
maintaining a device driver repository that includes a current device driver for each supported device included within the master list of supported devices.

11. The computer program product of claim 10 further comprising instructions for:
comparing the status of each previously-installed device driver included within the list of identified devices to the status of each corresponding current device driver included within the device driver repository.

12. The computer program product of claim 11 further comprising instructions for:
if the current device driver is newer than the previously-installed device driver, including the current device driver within the plurality of obtained device drivers.

13. The computer program product of claim 10 wherein the instructions for comparing the status of each previously-installed device driver includes instructions for one or more of:
comparing the version number of each previously-installed device driver to the version number of each corresponding current device driver;
comparing the age of each previously-installed device driver to the age of each corresponding current device driver;
comparing the release date of each previously-installed device driver to the release date of each corresponding current device driver;

14. The computer program product of claim 8 further comprising instructions for:
allowing a user to remove one or more device drivers from the plurality of obtained device drivers.

15. A computing system comprising:
at least one processor;
at least one memory architecture coupled with the at least one processor;
a first software module executed on the at least one processor and the at least one memory architecture, wherein the first software module is configured to perform operations including scanning a computing device to identify a plurality of devices included within the computing device, thus generating a list of identified devices;
a second software module executed on the at least one processor and the at least one memory architecture, wherein the second software module is configured to perform operations including comparing the list of identified devices to a master list of supported devices to identify a list of supported identified devices;
a third software module executed on the at least one processor and the at least one memory architecture, wherein the third software module is configured to perform operations including obtaining a device driver for each supported identified device included within the list of supported identified devices, thus generating a plurality of obtained device drivers; and
a fourth software module executed on the at least one processor and the at least one memory architecture, wherein the fourth software module is configured to perform operations including installing the plurality of obtained device drivers onto the computing device.

16. The computing system of claim 15 further comprising:
a fifth software module executed on the at least one processor and the at least one memory architecture, wherein the fifth software module is configured to perform operations including identifying a previously-installed device driver for each identified device included within the list of identified devices.

17. The computing system of claim 16 further comprising:
a sixth software module executed on the at least one processor and the at least one memory architecture, wherein the sixth software module is configured to perform operations including maintaining a device driver repository that includes a current device driver for each supported device included within the master list of supported devices.

18. The computing system of claim 17 further comprising:
a seventh software module executed on the at least one processor and the at least one memory architecture, wherein the seventh software module is configured to perform operations including comparing the status of each previously-installed device driver included within the list of identified devices to the status of each corresponding current device driver included within the device driver repository.

19. The computing system of claim 18 further comprising:
an eighth software module executed on the at least one processor and the at least one memory architecture, wherein the eighth software module is configured to perform operations including if the current device driver is newer than the previously-installed device driver, including the current device driver within the plurality of obtained device drivers.

20. The computing system of claim 17 wherein comparing the status of each previously-installed device driver includes one or more of:
comparing the version number of each previously-installed device driver to the version number of each corresponding current device driver;
comparing the age of each previously-installed device driver to the age of each corresponding current device driver;
comparing the release date of each previously-installed device driver to the release date of each corresponding current device driver;

21. The computing system of claim 15 further comprising:
an ninth software module executed on the at least one processor and the at least one memory architecture, wherein the ninth software module is configured to perform operations including allowing a user to remove one or more device drivers from the plurality of obtained device drivers.
